(19) United States
(12) Patent Application Publication
(10) Pub. No.: US 2014/0302411 A1
(43) Pub. Date: Oct. 9, 2014

(54) MEMBRANE HUMIDIFIER FOR FUEL CELL

(71) Applicant: Hyundai Motor Company, Seoul (KR)

(72) Inventors: Gi Young Nam, Yongin (KR); Hyun Wook Kim, Seoul (KR); Min Kyu Lee, Incheon (KR); Jin Woo Koo, Seoul (KR)

(73) Assignee: HYUNDAI MOTOR COMPANY, Seoul (KR)

(21) Appl. No.: 13/952,901

(22) Filed: Jul. 29, 2013

(30) Foreign Application Priority Data
Apr. 3, 2013 (KR) 10-2013-0036096

(51) Int. Cl. H01M 8/04

(52) U.S. Cl. CPC H01M 8/04291
USPC 429/413

(57) ABSTRACT

A membrane humidifier for a fuel cell is provided and includes a plurality of wet air channels and dry air channels and a cooling channel. The plurality of wet air channels and dry air channels are disposed across a moisture exchange membrane. The cooling channel is adjacently disposed across a wet air channel and a cooling channel separator to condense wet air that passes through the wet air channel.

### CROSS-REFERENCE TO RELATED APPLICATION

This application claims under 35 U.S.C. §119(a) the benefit of Korean Patent Application No. 10-2013-0036096 filed Apr. 3, 2013, the entire contents of which are incorporated herein by reference.

### BACKGROUND

(a) Technical Field

The present invention relates to a membrane humidifier for a fuel cell. More particularly, it relates to a membrane humidifier for a fuel cell, which facilitates the condensation of wet air by adding a cooling channel to the membrane humidifier.

(b) Background Art

Generally, it is necessary to humidify an electrolyte membrane in a fuel cell for its operation. For technique, a type of humidifier that operates by a method in which a wet gas, i.e., an exhaust gas from the fuel cell exchanges moisture with a dry gas supplied from the outside has been used.

As shown in FIG. 7, an air supply system of a fuel cell is configured to include a blower 20 that suctions exterior air and a membrane humidifier 30 that humidifies dry air (e.g., exterior air) from the blower 20 to supply the humidified air to a cathode of a fuel cell stack.

As shown in FIG. 6, a typical membrane humidifier, which supplies humid air to a cathode of a fuel cell stack, is manufactured in a stacked structure in which a first moisture exchange membrane 31 and a second moisture exchange membrane 32 are stacked across a support 33. Thus, a gap between the first and second moisture exchange membranes 31 and 32 becomes a wet air channel 34 through which wet air passes, i.e., exhaust gas from a fuel cell stack 10. In addition, a dry air channel 35 may be formed over the first moisture exchange membrane 21 and under the second moisture exchange membrane 32 to allow air from the blower 20 to pass there through.

Accordingly, when dry air suctioned by the blower 20 passes through the dry air channel 35 of the membrane humidifier 30, and simultaneously, wet air exhausted from the fuel cell stack 10 passes through the wet air channel 34 of the membrane humidifier 30, moisture contained in wet air passes the first and second moisture exchange membranes 31 and 22 to enter the dry air channel 35, and thus dry air flowing in the dry air channel 35 is humidified to be supplied to the cathode of the fuel cell stack 10.

In particular, wet air that passes through the wet air channel 34 must be smoothly condensed to allow moisture of wet air exhausted from the fuel cell stack 10 to pass through the first and second moisture exchange membranes 31 and 32 to be easily delivered to the dry air channel 35.

However, when the temperature of dry air that is suctioned by the blower and then supplied to the dry channel of the membrane humidifier is higher than the temperature of wet air exhausted from the fuel cell stack, the internal temperature of the membrane humidifier increases to a temperature higher than the temperature of wet air, and thus the condensation of wet air becomes poor, reducing the humidification efficiency for dry air.

To overcome these limitations, as shown in FIG. 8, a separate heat exchanger (e.g., an intercooler) 40 is installed at the front end of the membrane humidifier 30 to lower the temperature of dry air supplied from the blower 20 to the membrane humidifier 30. However, using the separate heat exchange requires significant volume and installation space for installment and connection of an air pipe for circulating cooling water to the intercooler. Also, there is a limitation in that the packaging volume for the air supply system of the fuel cell increases.

The above information disclosed in this section is only for enhancement of understanding of the background of the invention and therefore it may contain information that does not form the prior art that is already known in this country to a person of ordinary skill in the art.

### SUMMARY

The present invention provides a membrane humidifier for a fuel cell, which can smooth the condensation of wet air and minimize the volume for an air supply system of a fuel cell, by further forming a cooling water channel that may condense air passing through a wet air channel in addition to a dry air channel and a wet air channel in a membrane humidifier.

In one aspect, the present invention provides a membrane humidifier for a fuel cell that may include: two or more wet air channels and dry air channels disposed across a moisture exchange membrane; and a cooling channel adjacently disposed across a wet air channel and a cooling channel separator to condense wet air passing through the wet air channel.

In an exemplary embodiment, the wet air channel may include a first wet air channel and a second wet air channel disposed over and under the cooling channel, respectively. The dry air channel may include a first dry air channel and a second dry air channel disposed over the first wet air channel and under the second wet air channel, respectively.

In another exemplary embodiment, the cooling channel separator may be a hexagonal plate, may have a structure in which upper and lower supports are integrally disposed on upper and lower surfaces of an edge of the cooling channel separator, and may include a first cooling channel separator and a second cooling channel separator that are stacked.

In still another exemplary embodiment, the surfaces of the first and second cooling channel separators, which contact wet air, may be treated by water repellent coating.

In yet another exemplary embodiment, in the cooling channel, when the first and second cooling channel separators are stacked, the lower support of the first cooling channel separator and the upper support of the second cooling channel separator may contact each other to form a gap between the first and second cooling channel separators.

In still yet another exemplary embodiment, the membrane humidifier may include upper and lower plates that are hexagonal plates and have upper and lower supports integrally formed on upper and lower surfaces of an edge of the upper and lower plates to form the wet air channel and the dry air channel.

In a further exemplary embodiment, the upper plate may be stacked over the first cooling channel separator of the cooling channel separator across the first moisture exchange membrane, and the lower plate may be stacked under the second cooling channel separator across the second moisture exchange membrane.

In another further exemplary embodiment, a gap between the first cooling channel separator and the first moisture exchange membrane may form a first wet air channel in a gap that is formed by allowing the upper support of the first cooling channel separator to contact the lower support of the upper plate. In addition, a gap between the second cooling channel separator and the second moisture exchange membrane may form a second wet air channel in a gap that is formed by allowing the lower support of the second cooling channel separator to contact the upper support of the lower plate.

In yet another further exemplary embodiment, a gap between the upper plate and the first moisture exchange membrane may form a first dry air channel, and a gap between the lower plate and the second moisture exchange membrane may form a second dry air channel.

In still yet another further exemplary embodiment, the cooling channel, the wet air channels, and the dry air channels may have an inlet and an outlet that are formed in three different directions, allowing cooling water, wet air, and the dry air to cross each other in the three directions. The cooling water inlet and the cooling outlet of the cooling channel may be formed by removing the lower support from two surfaces opposite to each other among six surfaces of the first cooling channel separator and the upper support from the same two surfaces among six surfaces of the second cooling channel separator. Furthermore, the wet air inlet and the wet air outlet of the first wet air channel of the wet air channel may be formed by removing the upper support from two surfaces opposite to each other among six surfaces of the first cooling channel separator, and the wet air inlet and the wet air outlet of the second wet air channel may be formed by removing the lower support from the same two surfaces among six surfaces of the second cooling channel separator.

In addition, the dry air inlet and the dry air outlet of the first dry air channel of the dry air channel may be formed by removing the lower support from two surfaces opposite to each other among six surfaces of the upper plate, and the dry air inlet and the dry air outlet of the second dry air channel may be formed by removing the upper support from the same two surfaces among six surfaces of the upper plate.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is an exemplary detailed view illustrating a membrane humidifier for a fuel cell according to an embodiment of the present invention;

FIG. 2 is an exemplary assembled view illustrating a membrane humidifier for a fuel cell according to an embodiment of the present invention;

FIG. 3 is an exemplary cross-sectional view illustrating a membrane humidifier for a fuel cell according to an embodiment of the present invention;

FIGS. 4A and 4B are exemplary views illustrating a fluid flow direction in a membrane humidifier for a fuel cell according to an embodiment of the present invention;

FIG. 5 is an exemplary view illustrating an air supply system of a fuel cell including a membrane humidifier according to an embodiment of the present invention;

FIG. 6 is an exemplary cross-sectional view illustrating a typical membrane humidifier; and

FIGS. 7 and 8 are exemplary views illustrating an air supply system of a fuel cell including a typical membrane humidifier.

Reference numerals set forth in the Drawings includes reference to the following elements as further discussed below:

| 10: | fuel cell stack | 20: | blower |
|---|---|---|---|
| 30: | membrane humidifier | 40: | heat exchanger |
| 50: | pump | 51: | radiator |
| 100: | membrane humidifier | 110: | wet air channel |
| 111: | first wet air channel | 112: | second wet air channel |
| 116: | wet air inlet | 117: | wet air outlet |
| 120: | dry air channel | 121: | first dry air channel |
| 122: | second dry air channel | 126: | dry air inlet |
| 127: | dry air outlet | 130: | cooling channel |
| 131: | first cooling channel separator | 132: | second cooling separator |
| 133: | cooling channel separator | 134: | upper support |
| 135: | lower support | 136: | cooling water inlet |
| 137: | cooling water outlet | 141: | first moisture exchange |
| | | | membrane |
| 142: | second moisture exchange membrane 151: upper plate | | |
| 152: | lower plate | 154: | upper support |
| 155: | lower support | | |

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, fuel cell vehicles hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Hereinafter, exemplary embodiments of the present invention will be described in detail with reference to the accompanying drawings.

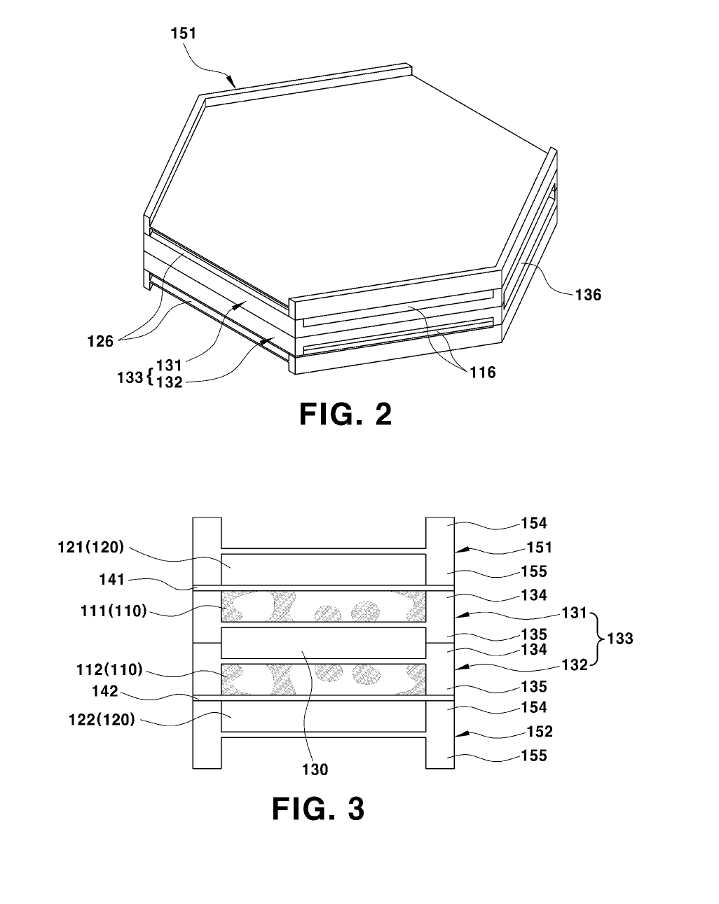

The present invention is focused on that wet air may be more smoothly condensed by further forming a cooling water channel that may condense wet air passing through a wet air channel, in addition to a dry air channel and the wet air channel inside a membrane humidifier for a fuel cell. Specifically, as shown in FIG. 3, a membrane humidifier 100 according to an exemplary embodiment of the present invention may include two or more wet air channels 110 and two or more dry air channels 120 that occupy independent space across a moisture exchange membrane, respectively. Particularly, the membrane humidifier 100 may further include a cooling channel 130 that is disposed adjacent to the wet air channel 110 and a cooling channel separator 133.

In other words, first and second wet air channels 111 and 112 of the wet air channel 110 may be disposed at an upper side and a lower side of the cooling channel 130, respectively. A first dry air channel and a second dry air channel of the dry air channel 120 may be disposed over the first wet air channel 111 and under the second wet air channel 112, respectively.

Hereinafter, a configuration for forming a cooling channel, a wet air channel, and a dry air channel of a membrane humidifier according to an exemplary embodiment of the present invention will be described as follows.

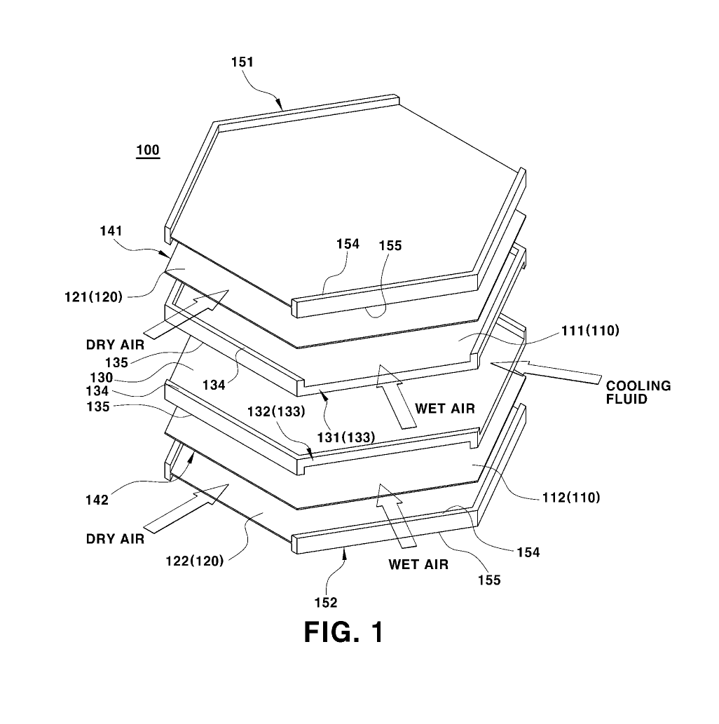

As shown in FIGS. 1 and 2, a cooling channel separator 133 may be disposed to form a cooling channel at the central portion of the membrane humidifier. First and second moisture exchange membranes 141 and 142 may be disposed at an upper side and a lower side of the cooling channel separator 133 to form a wet air channel. In addition, upper and lower plates 151 and 152 may be disposed at the outer sides of the first and second moisture exchange membranes 141 and 142 to form a dry air channel.

The surface of the cooling channel separator 133 may be treated by water-repellent coating. In addition, the cooling channel separator 133 may be a hexagonal plate, and may include first and second cooling channel separator 131 and 132 in which an upper support 134 and a lower support 135 are integrally formed at the upper and lower surfaces of the edge of the cooling channel separator 133.

Accordingly, when the first and second cooling channel separators 131 and 132 are stacked, the lower support 135 of the first cooling channel separator 131 may contact the upper support 134 of the second cooling channel separator 132 to form a gap between the first and second cooling channel separators 131 and 132. The gap may be a cooling channel 130 through which cooling fluid may flow.

The upper plate 151 and the lower plate 152 may also be hexagonal plates, and an upper support 154 and a lower support 155 may be integrally formed on the upper and lower surfaces of the edge thereof. Thus, when the first moisture exchange membrane 141 is stacked on the first cooling channel separator 131 of the cooling channel separator 133 and then the upper plate 151 is stacked thereon, the upper support 134 of the first cooling channel separator 131 contacts the lower support 155 of the upper plate 151 across the first moisture exchange membrane 141. Thus, a gap may be formed between the first cooling channel separator 131 and the first moisture exchange membrane 141, and simultaneously, another gap may be formed between the first moisture exchange membrane 141 and the upper plate 151.

Accordingly, the gap between the first cooling channel separator 131 and the first moisture exchange membrane 141 may be a first wet air channel 111, and the gap between the first moisture exchange membrane 141 and the upper plate 151 may be a first dry air channel 121.

In addition, when the second moisture exchange membrane 142 is stacked under the second cooling channel separator 132 of the cooling channel separator 133 and then the lower plate 152 is stacked thereunder, the lower support 135 of the second cooling channel separator 132 contacts the upper support 154 of the lower plate 152 across the second moisture exchange membrane 142. Thus, a gap may be formed between the second cooling channel separator 132 and the second moisture exchange membrane 142, and simultaneously, another gap may be formed between the second moisture exchange membrane 142 and the lower plate 152.

Accordingly, the gap between the second cooling channel separator 132 and the second moisture exchange membrane 142 may be a second wet air channel 112, and the gap between the second moisture exchange membrane 142 and the lower plate 152 may be a second dry air channel 122.

On the other hand, fluid inlets and outlets having three different directions (e.g., forming an angle of 60 degrees with one another) may be formed at the cooling channel 130, the wet air channel 110 including the first and second wet air channels 111 and 112, and the dry air channel 120 including the first and second dry air channels 121 and 122.

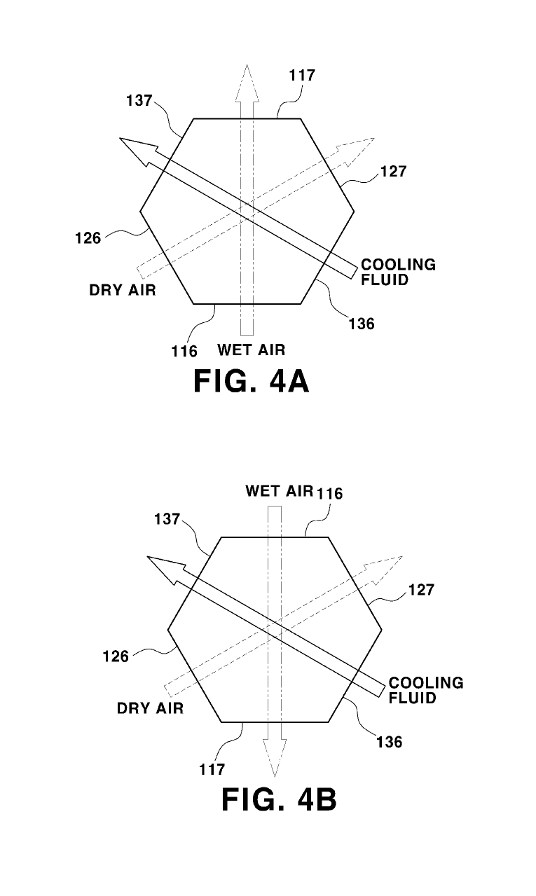

As shown in FIGS. 4A and 4B, a cooling water inlet 136 and a cooling water outlet 137 formed at the inlet and outlet of the cooling channel 130, a wet air inlet 116 and a wet air outlet 117 formed at the inlet and outlet of the wet air channel 110, and a dry air inlet 126 and a dry air outlet 127 formed at the inlet and outlet of the dry air channel 120 may be formed in three different directions, allowing cooling water, wet air, and dry air to cross each other in the three directions.

Specifically, the cooling water inlet 136 and the cooling water outlet 137 of the cooling channel 130 may be formed by removing the lower support 135 from two opposite surfaces (among six surfaces) of the first cooling channel separator 131 and simultaneously removing the upper support 134 from the same two surfaces (at the side where the lower support of the first cooling channel plate is removed) of the second cooling channel separator 132.

Additionally, the wet air inlet 116 and the wet air outlet 117 of the first wet air channel 111 of the wet air channel 110 may be formed by removing the upper support 134 from two opposite surfaces (among six surfaces) of the first cooling channel separator 131. The wet air inlet 116 and the wet air outlet 117 of the second wet air channel 112 may be formed by removing the lower support 135 from the same two opposite surfaces (at the side where the upper support of the first cooling channel plate is removed) of the second cooling channel separator 132.

Furthermore, the dry air inlet 126 and the dry air outlet 127 of the first dry air channel 121 of the dry air channel 120 may be formed by removing the lower support 155 from two opposite surfaces (among six surfaces) of the upper plate 151. The dry air inlet 126 and the dry air outlet 127 of the second dry air channel 122 may be formed by removing the upper support 154 from the same two opposite surfaces (at the side where the lower support of the upper plate is removed) of the lower plate 152.

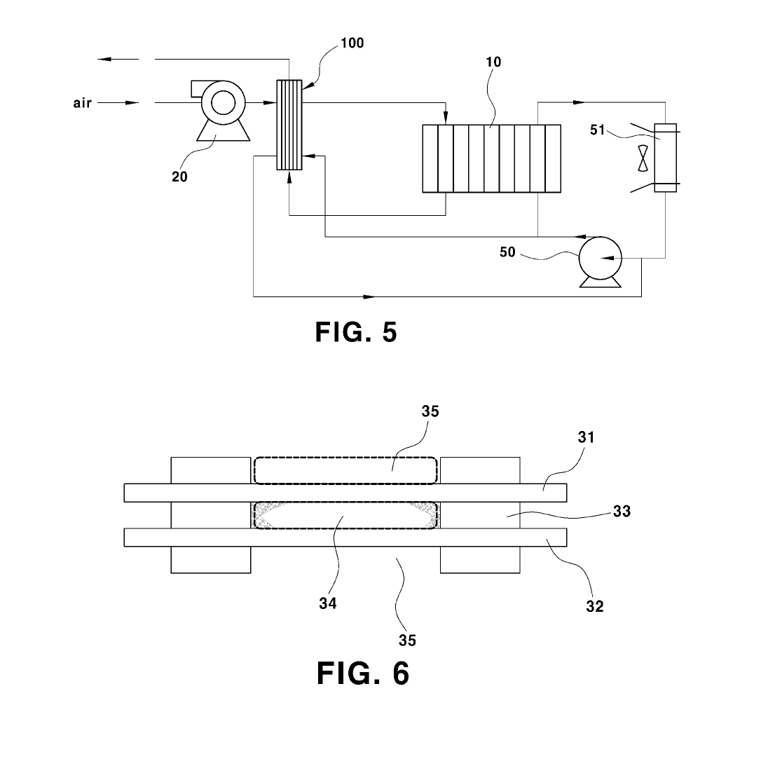

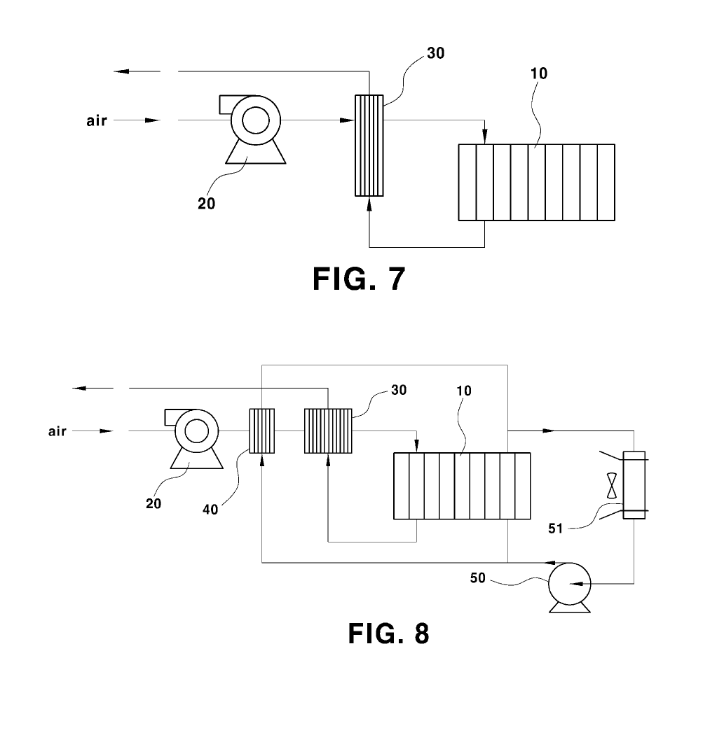

On the other hand, as shown in FIG. 5 illustrating an air supply system for a fuel cell, in an exemplary configuration of a cooling system (e.g., heat and water management system) of a fuel cell, the cooling water inlet 136 of the cooling water channel 130 may be connected to the outlet of a pump 50 connected to a radiator 51, and the inlet of the pump 50 may be connected to the cooling water outlet 137 of the cooling water channel 130.

Accordingly, exhaust gas from a fuel cell stack 10, (i.e., wet gas) may be supplied to the first and second wet air channels 111 and 112, and dry air supplied from a blower 20 may be supplied to the first and second dry air channels 121 and 122 of the dry air channel 120. Simultaneously, cooling water may be supplied from the outlet of the pump 50 to the fuel cell stack 10, and simultaneously, may be supplied to the cooling channel 130 of the membrane humidifier. Thus, wet air flowing in the wet air channel 110 may be easily condensed by cooling water that flows in the cooling channel 130, and condensate water may penetrate the first and second moisture exchange membranes 141 and 142 to be supplied to the dry air channel 120, thereby facilitating humidification of dry air in the dry air channel 120.

As described above, since the cooling channel in which cooling water flows may be combined with the dry air channel and the wet air channel in the membrane humidifier for the fuel cell, the condensation of wet air in the wet air channel may be smoothly performed by cooling water that flows in the cooling channel, and thus the humidification efficiency for dry air may be improved. In addition, since a typical intercooler and pipes connected thereto may be omitted, the volume of an air supply system of a fuel cell may be minimized

The invention has been described in detail with reference to exemplary embodiments thereof. However, it will be appreciated by those skilled in the art that changes may be made in these embodiments without departing from the principles and spirit of the invention, the scope of which is defined in the accompanying claims and their equivalents.

What is claimed is:

1. A membrane humidifier for a fuel cell, comprising:
a plurality of wet air channels and dry air channels disposed across a moisture exchange membrane; and
a cooling channel adjacently disposed across each wet air channel and a cooling channel separator to condense wet air passing through each wet air channel.

2. The membrane humidifier of claim 1, wherein the plurality of wet air channels includes: a first wet air channel and a second wet air channel disposed over and under the cooling channel, respectively, and the plurality of dry air channels includes a first dry air channel and a second dry air channel disposed over the first wet air channel and under the second wet air channel, respectively.

3. The membrane humidifier of claim 1, wherein the cooling channel separator is a hexagonal plate, has a structure in which an upper support and a lower support are integrally disposed on upper and lower surfaces of an edge of the cooling channel separator, and includes a first cooling channel separator and a second cooling channel separator that are stacked.

4. The membrane humidifier of claim 3, wherein surfaces of the first and second cooling channel separators, which contact wet air, are treated by a water repellent coating.

5. The membrane humidifier of claim 3, wherein in the cooling channel, when the first cooling channel separator and the second cooling channel separator are stacked, the lower support of the first cooling channel separator and the upper support of the second cooling channel separator contact each other to form a gap between the first cooling channel separator and the second cooling channel separator.

6. The membrane humidifier of claim 1, further comprising:
an upper plate and a lower plate that are hexagonal plates and have an upper support and a lower support integrally formed on upper and lower surfaces of an edge of the upper plate and the lower plate to form each wet air channel and each dry air channel.

7. The membrane humidifier of claim 6, wherein the upper plate is stacked over the first cooling channel separator of the cooling channel separator across the first moisture exchange membrane, and the lower plate is stacked under the second cooling channel separator across the second moisture exchange membrane.

8. The membrane humidifier of claim 7, wherein a gap between the first cooling channel separator and the first moisture exchange membrane forms a first wet air channel by allowing the upper support of the first cooling channel separator to contact the lower support of the upper plate.

9. The membrane humidifier of claim 7, wherein a gap between the second cooling channel separator and the second moisture exchange membrane forms a second wet air channel by allowing the lower support of the second cooling channel separator to contact the upper support of the lower plate.

10. The membrane humidifier of claim 7, wherein a gap between the upper plate and the first moisture exchange membrane forms a first dry air channel, and a gap between the lower plate and the second moisture exchange membrane forms a second dry air channel.

11. The membrane humidifier of claim 1, wherein the cooling channel, the plurality of wet air channels, and the plurality of dry air channels have an inlet and an outlet that are formed in three different directions, allowing cooling water, wet air, and the dry air to cross in three directions.

12. The membrane humidifier of claim 11, wherein the cooling water inlet and the cooling outlet of the cooling channel are formed by removing the lower support from two opposite surfaces of the first cooling channel separator and the upper support from the same two opposite surfaces of the second cooling channel separator.

13. The membrane humidifier of claim 11, wherein the wet air inlet and the wet air outlet of the first wet air channel of the wet air channel are formed by removing the upper support from two opposite surfaces of the first cooling channel separator, and the wet air inlet and the wet air outlet of the second wet air channel are formed by removing the lower support from the same two opposite surfaces of the second cooling channel separator.

14. The membrane humidifier of claim 11, wherein the dry air inlet and the dry air outlet of the first dry air channel of the dry air channel are formed by removing the lower support from two opposite surfaces of the upper plate, and the dry air inlet and the dry air outlet of the second dry air channel are formed by removing the upper support from the same two opposite surfaces of the upper plate.
